(19) United States
(12) Patent Application Publication
(10) Pub. No.: US 2010/0163019 A1
(43) Pub. Date: Jul. 1, 2010

(54) Conversion of cellulosic biomass to sugar

(76) Inventors: Michel Chornet, Stoke (CA); Esteban Chornet, Sherbrooke (CA); Jean-Michel Lavoie, Canton de Hatley (CA)

Correspondence Address: Raymond J. Lillie, Esq.;c/o Carella, Byrne, Bain, Gilfillan, Cecchi,, Stewart & Olstein, 5 Becker Farm Road, Roseland, NJ, 07068, US

(21) Appl. No.: 12/587,389

(22) Filed: Oct. 6, 2009

Related U.S. Application Data
(60) Provisional application No. 61/195,886, filed on Oct. 10, 2008.

(51) Int. Cl. C13K 1/02

(52) U.S. Cl. 127/37

(57) ABSTRACT

A process for converting wet cellulosic biomass to at least one sugar, such as glucose. The process comprises treating the wet cellulosic biomass with a strong acid at a temperature no greater than 40° C., wherein the acid is present in an amount of at least 10 moles per mole of monomeric sugar present in the wet cellulosic biomass. The acid then is neutralized partially, and the cellulose is hydrolyzed to the at least one sugar at a temperature of at least 60° C. Such process provides improved yields of sugar from cellulose.

This application claims priority based on provisional application Ser. No. 61/195,886, filed Oct. 10, 2008, the contents of which are incorporated by reference in their entirety.

This invention relates to the conversion of wet cellulosic biomass to at least one sugar, such as glucose. More particularly this invention relates to the conversion of wet cellulosic biomass to at least one sugar by treating the wet cellulosic biomass with a strong acid, and then partially neutralizing the acid and hydrolyzing the cellulose to at least one sugar.

The cellulose molecule is a linear polymer glucan bound by β-(1-4)-glycosidic linkages. The repeating unit is cellobiose, the dimer of glucose. The β-link causes a turning of one of the two glucose units around the C1-C4 axis. The chemical structure of cellulose is expressed as [C₆(H₂O)₅]ₙ. Native cellulose in wood or other plant materials may contain more than one thousand units of carbohydrate monomers.

Cellulose may be obtained from biomass or lignocellulosic materials, such as, for example, cotton stalks, corn cobs, corn stalks, corn husks, corn stover, banana stems, tapioca stems, castor stems, rice husks, rice bean, coconut husks and shells, jute sticks, wood, straw, and/or other plant material.

The biomass may be fractionated to provide hemicellulose and lignocellulose. The lignocellulose then is subjected to delignification to provide lignin and cellulose. For example, the lignocellulose may be subjected to a chemical pretreatment to modify the structure of the lignocellulosic material and to remove the lignin. For example, the lignocellulose may be subjected to a conventional pulping process, such as a Kraft process, to delignify the lignocellulose.

In one alternative, the lignocellulose may be preheated to about 120-150° C. in the presence of sulfur dioxide (SO₂) in an amount of about 20-100 kg SO₂ per ton of dry biomass. This causes a disruption in the lignin-carbohydrate association, whereby the cellulose is loosened from the lignin matrix.

In another alternative, the lignocellulose is subjected to caustic swelling, which swells and disrupts the lignin, and modifies the crystalline structure of the cellulose. Swelling agents include sodium hydroxide, certain amines, and anhydrous ammonia.

In yet another alternative, the lignin may be oxidized by an oxidizing agent, such as peracetic acid, whereby the cellulose is liberated for further treatment.

The cellulose then may converted to glucose in the presence of an enzymes. The cellulose can be converted to glucose in the presence of enzymes known as cellulases. Such enzymes include endoglucanases, cellobiohydrolases, exoglucohydrolases, and cellobiases. Endoglucanases partially degrade the native cellulose. Then endoglucanases and/or cellobiohydrolases cleave cellobiose units from the ends of insoluble celluloligosaccharides. The cellobiose is converted into glucose by cellobiase. Exoglucohydrolases and/or endoglucanases cleave glucose directly from the ends of long oligosaccharides. The cellulases may be obtained from any of a variety of organisms, such as bacteria such as, for example, Clostridium thermocellum and Clostridium themosaccharolyticum, fungi such as, for example, Trichoderma ressei, Trichoderma viride, Fusarium solani, Aspergillus niger, Penicillium funicolsum, and Cellumonas species, or molds.

The cost of converting cellulose to glucose, however, can be excessive. For example, cellulose is insoluble in many solvents, and some solvents in which the cellulose is soluble may denature the cellulase enzymes. In addition, if the cellulose is not separated completely from the lignin, additional expenses are incurred in removing the lignin from the cellulose.

Furthermore, if the cellulose has a crystalline, rather than an amorphous structure, only the exoglucohydrolase enzymes, which attack the terminal glucosidic bonds, will be effective in degrading the cellulose.

It is an object of the present invention to obtain at least one sugar from wet cellulosic biomass without the use of enzymes.

In accordance with an aspect of the present invention, there is provided a process for converting a wet cellulosic biomass to at least one sugar. The process comprises treating the wet cellulosic biomass with a strong acid at a temperature no greater than 40° C. The acid is present in an amount of at least 10 moles per mole of monomeric sugar present in the wet cellulosic biomass. The acid then is neutralized partially and the cellulose is hydrolyzed to the at least one sugar at a temperature of at least 60° C.

The term “monomeric sugar,” as used herein, means a sugar unit, such as a hexose or pentose sugar, that is present in a polymer contained in the wet cellulosic biomass. For example, the wet cellulosic biomass contains cellulose and, in some instances, may include other polysaccharide polymers such as hemicellulose. In cellulose, the monomeric sugar that is present is glucose. Hemicellulose, however, includes both pentose sugars, such as xylose and arabinose, as well as hexose sugars, such as glucose, galactose, and mannose. Thus, it is contemplated within the scope of the present invention that, although the wet cellulosic biomass to be treated within the scope of the present invention includes cellulose, which is comprised of monomeric glucose, such wet cellulosic biomass may also include additional polymers that include monomeric sugars other than glucose, such as other hexoses such as galactose and mannose, and pentoses such as xylose and arabinose.

In a non-limiting embodiment, water is present in the wet cellulosic biomass in an amount of from about 20 wt. % to about 80 wt. %. In another non-limiting embodiment, water is present in the wet cellulosic biomass in an amount of from about 40 wt. % to about 70 wt. %. In yet another non-limiting embodiment, water is present in the wet biomass in an amount of from about 55 wt. % to about 70 wt. %.

In a non-limiting embodiment, such wet cellulosic biomass may be obtained from a biomass or lignocellulosic material including, but not limited to, those hereinabove described. Such biomass or lignocellulosic material then is processed to provide a wet cellulosic biomass. In a non-limiting embodiment, the biomass is subjected to an aqueous ethanol extraction to provide extractives, and an extractives-free biomass. The extractives are subjected to further processing to provide products such as nutraceuticals, including, but not limited to, proanthocyanidins, maltol, taxans, tannins, fatty acids, sterols, and waxes. The extractives-free biomass, which includes fibrous residues, is subjected to steam treatment to produce a hemicellulose-rich liquor, rich in C₅ hemicellulosic sugars, and lignocellulose. The hemicellulosic liquor can be hydrolyzed into C₅ and C₆ sugars. The C₅ sugars may be converted into furfural and methylhydrofuran. The lignocellulose is impregnated with a caustic solution, such as, but not limited to, a 10-20 wt. % NaOH solution at a liquid to dry solids ratio of about 10:1, and then is heated to 160°-210° C. following a pre-established temperature time sequence to delignify the lignocellulose, thereby providing lignin and a wet cellulosic biomass.

The wet cellulosic biomass resulting from the previous treatment then is contacted with a strong acid. In general, the wet cellulosic biomass is contacted with the strong acid under conditions which decrystallize and swell the cellulose polymer, and whereby a gel is formed. In general, this is accomplished by treating the wet cellulosic biomass with the strong acid at a temperature that does not exceed 40° C., and wherein the strong acid is present in an amount of at least 10 moles per mole of monomeric sugar present in the wet cellulosic biomass.

In a non-limiting embodiment, the strong acid is an acid solution selected from the group consisting of sulfuric acid solution, nitric acid solution, and phosphoric acid solution. In another non-limiting embodiment, the acid solution is sulfuric acid solution.

In another non-limiting embodiment, the wet cellulosic biomass is treated with the strong acid at a temperature no greater than 35° C. In yet another non-limiting embodiment, the wet cellulosic biomass is treated with the strong acid at a temperature no greater than 30° C. In a further non-limiting embodiment, the wet cellulosic biomass is contacted with the strong acid at a temperature of from about 5° C. to no greater than 30° C.

In another non-limiting embodiment, the acid is present in an amount of at least 11 moles per mole of monomeric sugar present in the wet cellulosic biomass. In yet another non-limiting embodiment, the acid is present in an amount of at least 12 moles per mole of monomeric sugar present in the wet cellulosic biomass.

In another non-limiting embodiment, the concentration of the acid with respect to the acid solution and the water present in the wet cellulosic biomass is from about 70 wt. % to about 95 wt. %. In yet another non-limiting embodiment, the concentration of the acid with respect to the acid solution and the water in the wet cellulosic biomass is from about 70 wt. % to about 75 wt. %.

In another non-limiting embodiment, the wet cellulosic biomass is treated with the strong acid for a period of time of from about 10 minutes to about 120 minutes. In yet another non-limiting embodiment, the wet cellulosic biomass is treated with the strong acid for a period of time of from about 30 minutes to about 75 minutes.

Although the scope of the present invention is not to be limited to any theoretical reasoning, it is believed, as noted hereinabove, that the addition of the strong acid to the wet cellulosic biomass at a temperature which does not exceed 40° C. decrystallizes and swells the cellulose polymer, and breaks hydrogen bonds in the cellulose polymer, whereby a gel is formed.

Subsequent to the addition of the strong acid to the wet cellulosic biomass as hereinabove described, the acid is neutralized partially and the cellulose is hydrolyzed to at least one sugar at a temperature of at least 60° C.

In a non-limiting embodiment, the acid is neutralized partially by adding a base to strong acid and treated wet cellulosic biomass. Examples of bases which may be employed include, but are not limited to, ammonia, sodium hydroxide, potassium hydroxide, calcium hydroxide, magnesium hydroxide, and mixtures thereof. In a non-limiting embodiment, the base is ammonia. In one non-limiting embodiment, the ammonia is added to the treated wet cellulosic biomass and strong acid as a gas. In another non-limiting embodiment, the ammonia is added to the strong acid and treated wet cellulosic biomass as an aqueous solution, such as, for example, an ammonium hydroxide solution.

The base is added in an amount which effects partial neutralization of the acid. In a non-limiting embodiment, the base is added in an amount which results in a molar ratio of acid to base of from about 1.6 to about 2.6. In another non-limiting embodiment, the base is added in an amount which results in a molar ratio of acid to base of from about 1.6 to about 2.0.

Upon addition of the base to the acid and treated wet cellulosic biomass, the resulting mixture of base, acid, and wet cellulosic biomass is heated to a temperature which is sufficient to hydrolyze the cellulose to at least one sugar. In a non-limiting embodiment, the mixture is heated to a temperature of at least 60° C. In another non-limiting embodiment, the mixture is heated to a temperature of at least 80° C. In another non-limiting embodiment, the mixture is heated to a temperature of at least 60° C., but does not exceed 130° C. In yet another non-limiting embodiment, the mixture is heated to a temperature of at least 60° C., but does not exceed 120° C. In a further non-limiting embodiment, the mixture is heated to a temperature of at least 80° C., but does not exceed 120° C.

Although the scope of the present invention is not to be limited to any particular theoretical reasoning, when the base is added to the acid and treated wet cellulosic biomass, the base partially neutralizes the acid, whereby ions from the base neutralize ions from the acid, and a salt may be formed. For example, when ammonia is added to a mixture of cellulose and sulfuric acid, the ammonium ions neutralize sulfate ions, and ammonium sulfate is formed as well. When the resulting mixture of cellulose, acid, and base is heated, the cellulose is hydrolyzed to at least one sugar.

The at least one sugar produced according to the process of the present invention includes, but is not limited to, glucose.

Although cellulose is comprised of repeating glucose units, the wet cellulosic biomass, in a non-limiting embodiment, prior to treatment may include additional polysaccharides, such as hemicellulose, for example, which include monosaccharide units other than glucose, such as, for example, other hexose units such as galactose and mannose, and pentose units such as xylose and arabinose. In such a non-limiting embodiment, when the process of the present invention is applied to a wet cellulosic biomass that also includes polysaccharides other than cellulose, such process also may provide monosaccharides other than glucose. Thus, for example, in a non-limiting embodiment, when the process of the present invention is applied to a wet cellulosic biomass which also includes hemicellulose, the process will provide, in addition to glucose, galactose, mannose, xylose, and arabinose.

Upon the hydrolysis of the cellulose to at least one sugar, such as glucose, a solution of the at least one sugar may be recovered by separating the acid and the base from the glucose solution by appropriate means known to those skilled in the art. In one non-limiting embodiment, the solution of the at least one sugar, such as glucose, is separated from the acid and the base by means of a bipolar ion exchange membrane or resin, whereby ions from the acid and ions from the base are separated from the sugar solution. In a non-limiting embodiment, the at least one sugar is separated from the acid and the base by means of a bipolar ion exchange resin which includes alternating cationic and anionic resins. In one non-limiting embodiment, the cationic resin includes sulfonic acid groups on a polystyrene or acrylic matrix. In another non-limiting embodiment, the anionic resin includes quarternary ammonium ions on a polystyrene or acrylic matrix. In yet another non-limiting embodiment, the bipolar ion exchange resin includes alternating sequences of sulfonic acid groups and quarternary ammonium ions on a polystyrene or acrylic matrix. Alternatively, the sugar solution may be separated from the acid and the base by electrodialysis.

Recovery of the base, such as ammonia, may be done by desorption from the ion exchange membrane or resin by stripping. If electrodialysis is employed, the ammonia may be stripped directly from the aqueous ammonia-rich solution, thereby producing an ammonia-rich gas. Alternatively, ammonium hydroxide may be produced.

Recovery of the acid may be done by desorption from the ion exchange membrane or resin followed by stripping and absorption in concentrated acid. If electrodialysis is employed, concentration of the acid may be done by multiple stage evaporation.

The invention now will be described with respect to the following examples; it is to be understood, however, that the scope of the present invention is not intended to be limited thereby.

In the following examples, glucose yields are calculated first by multiplying the glucose weight recovered by the molar factor (162.14/180.16), and then dividing the dry weight of the substrate multiplied by its normalized composition in glucose. Similar calculations are done for other sugar yields.

### EXAMPLE 1

30 grams of α-cellulose (Sigma), which includes 84.9 wt. % glucose units and 15.1 wt. % monosaccharide units from monosaccharides other than glucose, previously dried in an oven at 110° C., were mixed with 300 ml of sulfuric acid solution, at 72 wt. % sulfuric acid (H₂SO₄). During the mixing, the temperature was kept at a maximum of 30° C. Contact between the acid solution and the cellulose was maintained for 2 hours, during which swelling of the cellulose occurred. Formation of monomeric glucose and xylose was observed, representing up to 10% of the potential glucose and up to 40% of the potential xylose.

250 ml of ammonium hydroxide solution (28 wt. % NH₄OH) then were added to the acid solution, that contained the swollen cellulose, to effect partial neutralization of the acid.

The mixture of acid, ammonium hydroxide, and cellulose was divided into seven fractions, each fraction being essentially equal in mass. Each fraction was heated for a period of time between 20 minutes and 60 minutes, and at a temperature of 80° C. or 100° C.

At 80° C., the glucose yields did not exceed 40%, while at 100° C., glucose yields of 80% were obtained at hydrolysis times of 30, 40, and 60 minutes.

A small precipitate also was observed. Analysis of the precipitate indicated that it essentially was organic because it was consumed by combustion at 550° C.

The sugar concentration in the final hydrolyzate was slightly above 4 wt. %.

### EXAMPLE 2

30 grams of α-cellulose (Sigma), previously dried in an oven at 110° C., were mixed with 300 ml of a sulfuric acid solution, at 72 wt. % sulfuric acid (H₂SO₄). During the mixing, the temperature was kept at a maximum of 30° C. Contact between the cellulose and the acid solution was maintained for 2 hours, during which time swelling of the cellulose occurred.

Ammonium hydroxide solution, at 28 wt. % NH₄OH, was added to the acid and cellulose mixture in amounts to provide molar ratios of sulfuric acid to ammonium hydroxide of 1.6, 1.8, 2.0, 2.2, and 2.4, to effect partial neutralization of the sulfuric acid.

The mixtures of the acid, ammonium hydroxide, and cellulose were heated at 100° C. for 30 minutes. Glucose yields were above 80%, and xylose yields were 80%.

### EXAMPLE 3

30 g of α-cellulose (Sigma), previously dried in an oven at 110° C., were mixed with 300 ml of sulfuric acid solution, at 72 wt. % sulfuric acid (H₂SO₄). During the mixing, the temperature was kept at a maximum of 30° C. Contact between the acid and the cellulose was maintained for two hours, and swelling of the cellulose occurred.

Ammonia gas (NH₃) then was added to the acid solution containing the swollen cellulose, such that the molar ratio of acid to ammonia was 1.6, to effect partial neutralization of the acid. The mixture of acid, ammonia (converted in situ to ammonium hydroxide), and cellulose was heated at 100° C. for 30 minutes.

Glucose yields were 82%, and the amount of glucose in the final hydrolyzate was 7 wt. %.

### EXAMPLE 4

30 g of cellulose, which was bleached and then dried in an oven at 105° C., was mixed with 300 ml of a sulfuric acid solution, at 72 wt. % sulfuric acid (H₂SO₄). The temperature during the mixing was kept at a maximum of 30° C. Contact between the acid and cellulose was maintained for 2 hours, and swelling occurred.

Ammonia gas (NH₃) then was added to the acid solution containing the swollen cellulose such that the molar ratio of acid to ammonia was 1.6, to effect partial neutralization of the acid.

The mixture of acid, ammonia (converted in situ to ammonium hydroxide), and cellulose was heated at 100° C. for 30 minutes. Glucose yields were 81%, and the amount of glucose in the final hydrolyzate was 7 wt. %.

### EXAMPLE 5

30 grams of cellulose (Avicel), which includes 98.6 wt. % glucose units and 1.4 wt. % of monosaccharide units other than glucose, previously dried in an oven at 110° C., were mixed with 300 ml of a sulfuric acid solution, at 72 wt. % sulfuric acid (H₂SO₄). The temperature during the mixing was kept at a maximum of 30° C. Contact between the cellulose and the acid solution was maintained for 2 hours, and swelling of the cellulose occurred.

Ammonia gas (NH₃) then was added to the acid solution that contained the swollen cellulose such that the molar ratio of acid to ammonia was 1.8, to effect partial neutralization of the acid.

The mixture of acid, ammonia (converted in situ to ammonium hydroxide), and cellulose was heated for 30 minutes at 100° C. Glucose yields were 95%, and the amount of glucose in the final hydrolyzate was 8 wt. %.

### EXAMPLE 6

Wood from Populus tremuloides was subjected to ethanol extraction with a 50:50 mixture of ethanol and water at 80° C. The wet solids then were subjected to washing and pressing with hot water, and then treated with steam and then hot water to provide a wet lignocellulose. The wet lignocellulose then is impregnated with a caustic solution, and then treated with hot water to delignify the lignocellulose, and to provide a wet cellulose. The wet cellulose then was bleached. The lignin content of the resulting wet cellulose was 5.7 wt. %.

265.5 grams of the wet cellulose (101.7 grams of dry solids, the rest being moisture present after centrifuging the pulp) were mixed with 830 ml of a sulfuric acid solution, at 87 wt. % sulfuric acid (H₂SO₄). The wet cellulose was added under intense agitation and mixing. Prior to mixing, the sulfuric acid solution was cooled to 5° C. to ensure that during mixing, the temperature does not exceed 30° C., thereby preventing degradation of the cellulose. As the cellulose was mixed with the acid, swelling of the cellulose occurred. During the mixing of the cellulose and acid, the mixture was in contact with a heat exchanger, through which a cooling fluid was passed, to ensure that the temperature did not exceed 30° C. Contact between the cellulose and acid was maintained for 2 hours.

Ammonia gas (NH₃) then was added to the acid solution containing the swollen cellulose such that the molar ratio of acid to ammonia was 1.6, to effect the partial neutralization of the acid. The mixture of acid, ammonia (converted in situ to ammonium hydroxide), and cellulose then was heated to 120° C. for 30 minutes. Glucose yields were 98%, and the amount of glucose in the final hydrolyzate was 8 wt. %.

### EXAMPLE 7

Wet cellulose was prepared from wood, using Populus tremuloides as the wood material, as described in Example 6. The cellulose fines had an average size of 2 mm. The wet cellulose had a lignin content of 13.3 wt. %.

262.5 grams of the wet cellulose (100.5 grams of dry solids, the rest being moisture after centrifuging the pulp) were mixed with 830 ml of sulfuric acid solution, at 87 wt. % sulfuric acid (H₂SO₄). The wet cellulose was added to the acid under intense agitation and mixing. Prior to mixing, the sulfuric acid solution was cooled to 5° C. to ensure that the temperature during the mixing process did not exceed 30° C., to insure that degradation of the cellulose did not take place. During the mixing of the wet cellulose and the acid, the cellulose and acid were in contact with a heat exchanger, through which a cooling fluid was passed, to ensure that the temperature did not exceed 30° C. Contact between the wet cellulose and the acid was maintained for 2 hours, and swelling of the cellulose occurred.

Ammonia gas (NH₃) then was added to the acid solution containing the wet cellulose in an amount to provide an acid to ammonia molar ratio of 1.6. The mixture of acid, ammonia (converted in situ into ammonium hydroxide), and cellulose was heated to 130° C. for 30 minutes. Glucose yields were 95%, and the amount of glucose in the final hydrolyzate was 8 wt. %.

### EXAMPLE 8

Wet cellulose was obtained from wood, using Populus tremuloides as the wood material, as described in Example 6. The wet cellulose had a lignin content of 13.3 wt. %. The fines of the wet cellulose had an average size of 2 mm.

263.8 grams of the wet cellulose (100.7 grams of dry solids, the rest being moisture after centrifuging the pulp) were mixed with 830 ml of a sulfuric acid solution, at 87 wt. % sulfuric acid (H₂SO₄). The wet cellulose was added to the sulfuric acid solution under intense agitation and mixing. Prior to mixing the sulfuric acid solution was cooled to 5° C. to ensure that the temperature during the mixing process did not exceed 30° C., thereby preventing degradation of the cellulose. During the mixing, the wet cellulose and sulfuric acid were in contact with a heat exchanger, through which a cooling fluid was passed, to ensure that the temperature did not exceed 30° C. Contact between the cellulose and the acid was maintained for 2 hours, and swelling of the cellulose occurred.

Ammonia gas (NH₃) then was added to the acid solution containing the swollen cellulose such that the molar ratio of acid to ammonia was 2.2, to effect partial neutralization of the acid. The mixture of acid, ammonia (converted in situ into ammonium hydroxide), and cellulose was heated to 120° C. for 30 minutes. Glucose yields were 66%.

### EXAMPLE 9

Wet cellulose was obtained from wood, with Populus tremuloides being the source of the wood, was obtained as described in Example 6. The wet cellulose also was bleached with peroxide, and had a lignin content of 5.6 wt. %.

264.4 grams of the wet cellulose (100.9 grams of dry solids, the rest being moisture present after centrifuging the pulp) were mixed with 830 ml of sulfuric acid solution, at 87 wt. % sulfuric acid (H₂SO₄). The wet cellulose was added to the sulfuric acid solution under intense agitation and mixing. Prior to mixing, the solution was cooled to 5° C. to ensure that the temperature during the mixing process did not exceed 30° C., thereby preventing degradation of the cellulose, During the mixing, the cellulose and acid were in contact with a heat exchanger, through which a cooling fluid was passed, to ensure that the temperature did not exceed 30° C. Contact between the cellulose and the acid was maintained for 2 hours, and swelling of the cellulose occurred.

Ammonia gas (NH₃) then was added to the acid solution containing the swollen cellulose such that the molar ratio of acid to ammonia was 2.2, to effect partial neutralization of the acid.

The mixture of acid, ammonia (converted in situ to ammonium hydroxide), and cellulose was heated to 120° C. for 30 minutes. Glucose yields were 80%.

### EXAMPLE 10

Bleached and unbleached samples of wet cellulose were prepared as described in Examples 6 and 7, respectively. The samples then were contacted with sulfuric acid, and then ammonia as described in Examples 6 and 7, except that the molar ratio of acid to ammonia was varied between 1.6 and 2.0. The mixture of acid, ammonia (converted in situ to ammonium hydroxide), and cellulose was heated to 120° C. for 15 minutes. Glucose yields were 98% for bleached cellulose and 80% for unbleached cellulose.

### EXAMPLE 11

Bleached and unbleached wet cellulose samples were prepared as described in Example 10, contacted with sulfuric acid and ammonia, and the resulting mixtures of acid, ammonia (converted in situ to ammonium hydroxide), and cellulose were heated as described in Example 10, except that the mixtures were heated to 120° C. for 45 minutes. Glucose yields were 99% for bleached cellulose and 91% for unbleached cellulose.

### EXAMPLE 12

Bleached and unbleached wet cellulose samples were prepared as described in Example 10, contacted with sulfuric acid and ammonia, and the resulting mixtures of acid, ammonia (converted in situ to ammonium hydroxide), and cellulose were heated as described in Example 10, except that the mixtures were heated to 120° C. for 30 minutes. Glucose yields were 96% for bleached cellulose and 90% for unbleached cellulose.

### EXAMPLE 13

Bleached and unbleached wet cellulose samples were prepared as described in Example 10, contacted with sulfuric acid and ammonia, and the resulting mixtures of acid, ammonia (converted in situ to ammonium hydroxide), and cellulose, were heated as described in Example 10, except that the mixtures were heated to 100° C. for 30 minutes. Glucose yields were 91% for bleached cellulose and 80% for unbleached cellulose.

### EXAMPLE 14

Different species of wood (spruce, fir, pine, birch and maple), as well as corn stover and willows (3-year plantings), were subjected to ethanol extraction with a 50:50 mixture of ethanol and water at 80° C. The wet solids then were subjected to washing and pressing with hot water, and then treated with steam and then hot water to provide a wet lignocellulose. The wet lignocellulose then was impregnated with a caustic solution, and then treated with hot water to delignify the lignocellulose, and to provide a wet cellulose. The wet cellulose then was bleached. The lignin content of the resulting wet cellulose was comprised between 3 and 6 wt. %.

Between 250 and 300 grams of the wet cellulose (100-120 grams of dry solids, the rest being moisture present after centrifuging the pulp) were mixed with 750-950 ml of a sulfuric acid solution, at 85-87 wt. % sulfuric acid (H₂SO₄). The wet cellulose was added under intense agitation and mixing. Prior to mixing, the sulfuric acid solution was cooled to 5° C. to ensure that during mixing, the temperature did not exceed 30° C., thereby preventing degradation of the cellulose. As the cellulose was mixed with the acid, swelling of the cellulose occurred. During the mixing of the cellulose and acid, the mixture was in contact with a heat exchanger, through which a cooling fluid was passed, to ensure that the temperature did not exceed 30° C. Contact between the cellulose and acid was maintained for a maximum of 2 hours.

Ammonia gas (NH₃) then was added to the acid solution containing the swollen cellulose such that the molar ratio of acid to ammonia was 1.5-1.7, to effect the partial neutralization of the acid. The mixture of acid, ammonia (converted in situ to ammonium hydroxide), and cellulose then was heated to 120° C. for 30 minutes. Glucose yields were 90-98%, and the amount of glucose in the final hydrolyzate was 6-10 wt. %

### EXAMPLE 15

Wet cellulose was prepared from the same species as described in Example 14. The cellulose fines had an average size of 2 mm. The wet cellulose had lignin contents between 10.0 and 15.0 wt %.

250-300 grams of the wet cellulose (100.0-120.0 grams of dry solids, the rest being moisture after centrifuging the pulp) were mixed with 750-950 ml of sulfuric acid solution, at 85-87 wt. % sulfuric acid (H₂SO₄). The wet cellulose was added to the acid under intense agitation and mixing. Prior to mixing, the sulfuric acid solution was cooled to 5° C. to ensure that the temperature during the mixing process did not exceed 30° C., to insure that degradation of the cellulose did not take place. During the mixing of the wet cellulose and the acid, the cellulose and acid were in contact with a heat exchanger, through which a cooling fluid was passed, to ensure that the temperature did not exceed 30° C. Contact between the wet cellulose and the acid was maintained for 2 hours, and swelling of the cellulose occurred.

Ammonia gas (NH₃) then was added to the acid solution containing the wet cellulose in an amount to provide an acid to ammonia molar ratio of 1.4-1.7. The mixture of acid, ammonia (converted in situ into ammonium hydroxide), and cellulose was heated to 130° C. for 30 minutes. Glucose yields in the 90-95% range were observed, and the amount of glucose in the final hydrolyzate was 6-8 wt. %.

### EXAMPLE 16

Wet cellulose was obtained from the species described in Example 14, and using the same methodology. The wet cellulose had a lignin content of 10-15 wt. %. The fines of the wet cellulose had an average size of 2 mm.

250-300 grams of the wet cellulose (100.0-120.0 grams of dry solids, the rest being moisture after centrifuging the pulp) were mixed with 750-950 ml of a sulfuric acid solution, at 85-87 wt. % sulfuric acid (H₂SO₄). The wet cellulose was added to the sulfuric acid solution under intense agitation and mixing. Prior to mixing the sulfuric acid solution was cooled to 5° C. to ensure that the temperature during the mixing process did not exceed 30° C., thereby preventing degradation of the cellulose. During the mixing, the wet cellulose and sulfuric acid were in contact with a heat exchanger, through which a cooling fluid was passed, to ensure that the temperature did not exceed 30° C. Contact between the cellulose and the acid was maintained for 2 hours, and swelling of the cellulose occurred.

Ammonia gas (NH₃) then was added to the acid solution containing the swollen cellulose such that the molar ratio of acid to ammonia was 2.2, to effect partial neutralization of the acid. The mixture of acid, ammonia (converted in situ into ammonium hydroxide), and cellulose was heated to 120° C. for 30 minutes. Glucose yields were in the 60-70% range.

### EXAMPLE 17

Wet cellulose was obtained from several wood species as described in Example 14. The wet cellulose also was bleached with peroxide, and had a lignin content of 3 to 6 wt. %.

250-300 grams of the wet cellulose (100.0-120.0 grams of dry solids, the rest being moisture present after centrifuging the pulp) were mixed with 750-950 ml of sulfuric acid solution, at 85-87 wt. % sulfuric acid (H₂SO₄). The wet cellulose was added to the sulfuric acid solution under intense agitation and mixing. Prior to mixing, the solution was cooled to 5° C. to ensure that the temperature during the mixing process did not exceed 30° C., thereby presenting degradation of the cellulose. During the mixing, the cellulose and acid were in contact with a heat exchanger, through which a cooling fluid was passed, to ensure that the temperature did not exceed 30° C. Contact between the cellulose and the acid was maintained for 2 hours, and swelling of the cellulose occurred.

Ammonia gas (NH₃) then was added to the acid solution containing the swollen cellulose such that the molar ratio of acid to ammonia was 2.2, to effect partial neutralization of the acid.

The mixture of acid, ammonia (converted in situ to ammonium hydroxide), and cellulose was heated to 120° C. for 30 minutes. Glucose yields were in the 75-80% range.

### EXAMPLE 18

Bleached and unbleached samples of wet cellulose were prepared as described in Examples 14 and 15, respectively. The samples then were contacted with sulfuric acid, and then ammonia as described in Examples 14 and 15, respectively, except that the molar ratio of acid to ammonia was varied between 1.6 and 2.0. The mixture of acid, ammonia (converted in situ to ammonium hydroxide), and cellulose was heated to 120° C. for 15 minutes. Glucose yields were 95-98% for bleached cellulose and 75-85% for unbleached cellulose.

### EXAMPLE 19

Bleached and unbleached wet cellulose samples were prepared as described in Example 18, and then contacted with sulfuric acid and ammonia. The resulting mixtures of acid, ammonia (converted in situ to ammonium hydroxide), and cellulose were heated as described in Example 18, except that the mixtures were heated to 120° C. for 45 minutes. Glucose yields were 95-99% for bleached cellulose and 88-92% for unbleached cellulose.

### EXAMPLE 20

Bleached and unbleached wet cellulose samples were prepared as described in Example 18, and then contacted with sulfuric acid and ammonia. The resulting mixtures of acid, ammonia (converted in situ to ammonium hydroxide), and cellulose were heated as described in Example 18, except that the mixtures were heated to 120° C. for 30 minutes. Glucose yields were 92-96% for bleached cellulose and 86-90% for unbleached cellulose.

### EXAMPLE 21

Bleached and unbleached wet cellulose samples were prepared as described in Example 18, and then contacted with sulfuric acid and ammonia. The resulting mixtures of acid, ammonia (converted in situ to ammonium hydroxide), and cellulose, were heated as described in Example 18, except that the mixtures were heated to 100° C. for 30 minutes. Glucose yields were 88-92% for bleached cellulose and 76-82% for unbleached cellulose.

The disclosures of all patents and publications, including published patent applications, are incorporated herein by reference to the same extent as if each patent and publication were incorporated individually by reference.

It is to be understood, however, that the scope of the present invention is not to be limited to the specific embodiments described above. The invention may be practiced other than as particularly described and still be within the scope of the accompanying claims.

What is claimed is:

1. A process for converting a wet cellulosic biomass to at least one sugar, comprising:
(a) treating said wet cellulosic biomass with a strong acid at a temperature no greater than 40° C., wherein said acid is present in an amount of at least 10 moles per mole of monomeric sugar present in the wet cellulosic biomass; and
(b) partially neutralizing said acid and hydrolyzing the cellulose to said at least one sugar at a temperature of at least 60° C.

2. The process of claim 1 wherein said wet cellulosic biomass is treated with said strong acid at a temperature no greater than 35° C.

3. The process of claim 2 wherein said wet cellulosic biomass is treated with said strong acid at a temperature no greater than 30° C.

4. The process of claim 1 wherein said strong acid is selected from the group consisting of sulfuric acid solution, nitric acid solution, and phosphoric acid solution.

5. The process of claim 4 wherein said strong acid is sulfuric acid solution.

6. The process of claim 1 wherein said acid is present in an amount of at least 11 moles per mole of monomeric sugar present in the wet cellulosic biomass.

7. The process of claim 6 wherein said acid is present in an amount of at least 12 moles per mole of monomeric sugar present in the wet cellulosic biomass.

8. The process of claim 1 wherein said acid is neutralized partially by adding a base to said wet cellulosic biomass and said acid.

9. The process of claim 8 wherein said base is ammonia.

10. The process of claim 9 wherein said ammonia is added to said wet cellulosic biomass and said acid as a gas.

11. The process of claim 1 wherein said cellulose is hydrolyzed at a temperature of at least 80° C.

12. The process of claim 1 wherein said cellulose is hydrolyzed at a temperature that does not exceed 130° C.

13. The process of claim 11 wherein said cellulose is hydrolyzed at a temperature that does not exceed 120° C.

14. The process of claim 1 wherein water is present in said wet cellulosic biomass in an amount of from about 20 wt. % to about 80 wt. %.

15. The process of claim 14 wherein water is present in said wet cellulosic biomass in an amount of from about 40 wt. % to about 70 wt. %.

16. The process of claim 15 wherein water is present in said wet cellulosic biomass in an amount of from about 55 wt. % to about 70 wt. %.

17. The process of claim 1 wherein said at least one sugar is glucose.
